(19) United States
(12) Patent Application Publication
(10) Pub. No.: US 2023/0382355 A1
(43) Pub. Date: Nov. 30, 2023

(54) MULTI-PURPOSE TOOL

(71) Applicant: Andrew Melamed, Bradenton, FL (US)

(72) Inventor: Andrew Melamed, Bradenton, FL (US)

(21) Appl. No.: 18/322,718

(22) Filed: May 24, 2023

Related U.S. Application Data
(60) Provisional application No. 63/345,129, filed on May 24, 2022.

(51) Int. Cl. B60S 3/04

(52) U.S. Cl. CPC B60S 3/045

(57) ABSTRACT

Provided is a multi-purpose tool for vehicles. The tool includes a body portion, an outer edge portion, and a first handle portion. The body portion has a front surface and a back surface. The outer edge portion extends around a periphery of the body portion and extends away from the back surface of the body portion in an extension direction. The back surface of the body portion and the outer edge portion define a cavity. The first handle portion is defined by an opening in the body portion.

This application claims the benefit of U.S. Provisional Application No. 63/345,129 filed May 24, 2022, which is hereby incorporated herein by reference.

### TECHNICAL FIELD

The present invention relates generally to an apparatus and method for removing snow, mud, or other unwanted substance from an exterior of a vehicle and for protecting an interior of a vehicle.

### BACKGROUND OF THE INVENTION

Automobile snow removal tools typically include a brush and/or an ice scraper attached to a handle. In some automobile snow removal tools, the brush and the ice scraper are arranged on opposite ends of the handle. After a snow and/or ice storm, a user may remove loose snow from their vehicle by using the brush of the tool and may chisel ice of off their vehicle using the ice scraper of the tool.

Both the brush and the ice scraper of an automobile snow removal tool are a fraction of a width of a windshield. For example, the brush may be about four inches to about twelve inches wide, and the ice scraper may be about three inches to about six inches wide. Thus, a user will make several passes with the brush and/or ice scraper to remove snow and ice from the windshield.

### SUMMARY OF THE INVENTION

According to one aspect, a multi-purpose tool for vehicles is provided. The tool includes a body portion, an outer edge portion, and a first handle portion. The body portion has a front surface and a back surface. The outer edge portion extends around a periphery of the body portion and extends away from the back surface of the body portion in an extension direction. The back surface of the body portion and the outer edge portion define a cavity. The first handle portion is defined by an opening in the body portion.

According to another aspect, a multi-purpose tool for automobiles is provided. The multi-purpose tool includes a body portion having a front surface and a back surface. An outer edge portion extends around a periphery of the body portion and extends away from the back surface of the body portion in an extension direction. The back surface of the body portion and the outer edge portion define a cavity. The multi-purpose tool additionally includes a first handle portion defined by an opening extending through the body portion, the first handle portion is configured to accommodate fingers of a user's hand for gripping. A gripping side of the outer edge portion is configured to accommodate a thumb of the user's hand when gripping the first handle portion. The outer edge portion includes a scraping side arranged opposite to the gripping side.

According to still another aspect, a method of removing a substance from a vehicle is provided. The method includes: gripping a gripping side of a multi-purpose tool at a first handle portion, the multi-purpose tool including a body portion having a front surface and a back surface, an outer edge portion extending around a periphery of the body portion and extending away from the back surface of the body portion, wherein the back surface of the body portion and the outer edge portion define a main cavity, and the first handle portion defined by an opening integrated with the body portion; applying a scraping region of edge portion of the multi-purpose tool to an exterior area of the vehicle that includes the substance, the scraping region of the edge portion being opposite to the gripping side of the multi-purpose tool; removing the substance from the exterior area of the v with the scraping region of the edge portion of the multi-purpose tool, wherein the removal step is conducted by: pushing the substance off of the exterior area of the vehicle with the scraping region of the edge portion of the multi-purpose tool, wherein the pushing is conducted in a first direction; and pulling the substance off of the exterior area of the vehicle with the scraping region of the edge portion of the multi-purpose tool, wherein the pulling is conducted in a second direction opposite to the first direction.

The foregoing and other features of the application are described below with reference to the drawings.

### BRIEF DESCRIPTION OF THE DRAWINGS

FIG. 1 is a perspective view of a back side of an exemplary multi-purpose tool.

FIG. 2 is a perspective view of a front side of the exemplary multi-purpose tool.

FIG. 3 is a front view of a front side of the exemplary multi-purpose tool.

FIG. 4 is a side view of the exemplary multi-purpose tool.

FIG. 5 is a side view of some embodiments of the exemplary multi-purpose tool.

FIG. 6 is a perspective view of another embodiment of an exemplary multi-purpose tool.

FIG. 7 is a side view of the another embodiment of an exemplary multi-purpose tool of FIG. 6.

FIGS. 8, 9, 10, 11, 12, and 13 illustrate various alternative embodiments of multi-purpose tools.

FIG. 14 is a stack of multiple multi-purpose tools.

FIGS. 15, 16, 17, and 18 illustrate a method of gripping and using an exemplary multi-purpose tool for removal of a substance from an exterior of a vehicle.

### DETAILED DESCRIPTION OF THE INVENTION

Embodiments of the application relate to methods and systems that relate to a multi-purpose tool to remove a substance from a vehicle. The multi-purpose tool includes a body portion having a front surface and a back surface. An outer edge portion extends around a periphery of the body portion and extends away from the back surface of the body portion in an extension direction. The back surface of the body portion and the outer edge portion define a cavity. A first handle portion is defined by an opening in the body portion.

With reference to the drawings, like reference numerals designate identical or corresponding parts throughout the several views. However, the inclusion of like elements in different views does not mean a given embodiment necessarily includes such elements or that all embodiments of the application include such elements. The examples and figures are illustrative only and not meant to limit the application, which is measured by the scope and spirit of the claims.

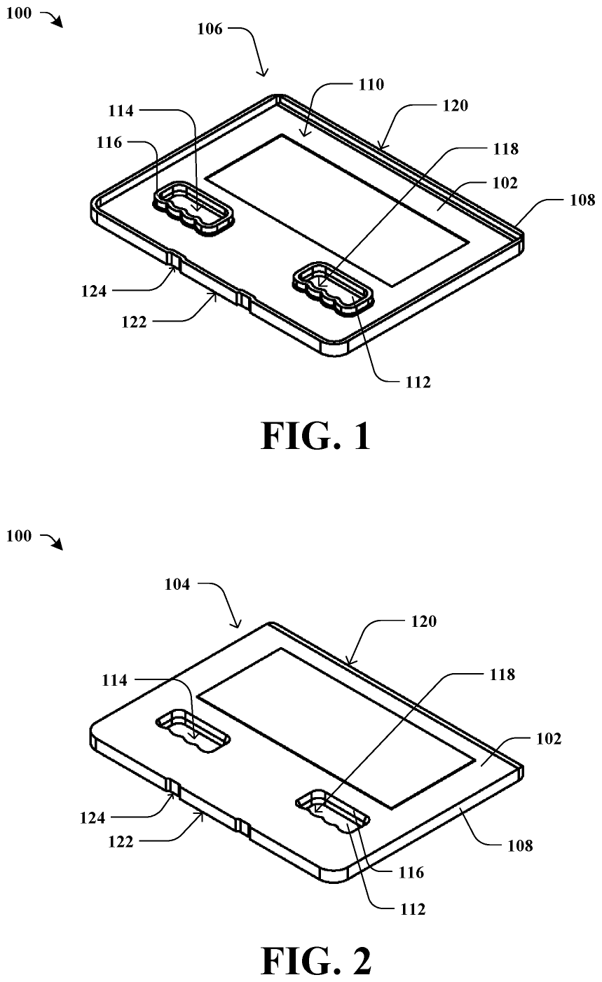

Turning now to FIGS. 1 and 2, an exemplary multi-purpose tool is shown at reference numeral 100. The multi-purpose tool is configured to easily and efficiently remove a substance (e.g., snow, ice, mud, leaves, water, etc.) from an exterior surface of a vehicle. The multi-purpose tool can also be used year-round to protect an interior surface of a vehicle from substances. FIG. 1 illustrates a perspective view of a back side of the multi-purpose tool, and FIG. 2 illustrates a perspective view of a top side of the multi-purpose tool.

The multi-purpose tool includes a body portion 102 having a front surface 104 and a back surface 106. The body portion 102 is a substantially planar-like structure that extends in two-dimensions and has a small thickness in a third dimension. In some embodiments, the body portion 102 may generally be rectangular or square-like in shape. The tool further includes an outer edge portion 108 extending around a periphery of the body portion 102. The outer edge portion 108 extends away from the body portion 102 in an extension direction perpendicular to the back surface 106 of the body portion 102. In some embodiments, the outer edge portion 108 may completely surround all outer edges of the body portion 102, and in other embodiments, there may be gaps or spaces in the outer edge portion 108. The outer edge portion 108 and the body portion 102 define a main cavity 110.

The multi-purpose tool further includes handle portions 112 integrated with the body portion 102. In some embodiments, the handle portions 112 are defined by openings 114 that extend through the body portion 102. In some embodiments, an inner edge portion 116 extending in the extension direction surrounds and defines the opening 114. In such embodiments, the main cavity 110 is defined by space confined by the body portion 102, the outer edge portion 108, and the inner edge portion 116 of the multi-purpose tool. In some embodiments, the multi-purpose tool includes two handle portions 112 laterally spaced apart from one another. Each handle portion 112 includes finger notches 118 configured to accommodate fingers of a user's hand for gripping.

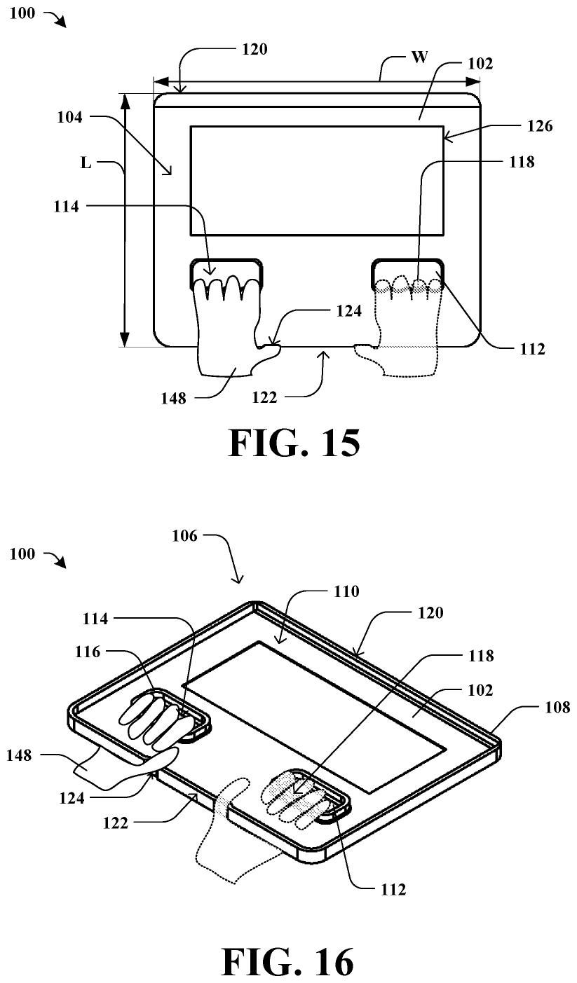

The outer edge portion 108 includes a scraping side 120 along a first edge of the body portion 102 and a gripping side 122 along a second edge of the body portion 102 arranged opposite to the first side of the body portion 102. The handle portions 112 are arranged closer to the gripping side 122 than to the scraping side 120. As will be discussed further in FIGS. 15 and 16, the gripping side 122 is configured for gripping by a user's hand at the handle portions 112, and the scraping side 120 is configured to be come into contact with a vehicle and/or substance on a vehicle to remove the substance from the vehicle. In some embodiments, the gripping side 122 of the outer edge portion 108 includes thumb notches 124 that extend inward towards the handle portions 112. The thumb notches 124 are configured to accommodate a user's thumb when gripping the handle portions 112.

In some embodiments, at least the body portion 102 and the outer edge portion 108 are monolithic or molded from a single piece. For example, as shown the body portion 102, the outer edge portion 108, and the handle portions 112 are monolithic or molded from a single piece. A suitable process may be used to form the tool, such as by injection molding, providing improved durability because weak joints between two parts are avoided, and any suitable color may be used for marketing purpose. The multi-purpose tool may be made from a suitable material that can withstand a range of temperatures, that is lightweight, and that is slightly flexible. For example, the multi-purpose tool may be made of a suitable plastic such as polyethylene, recycled polyethylene, polypropylene, polycarbonate, etc.

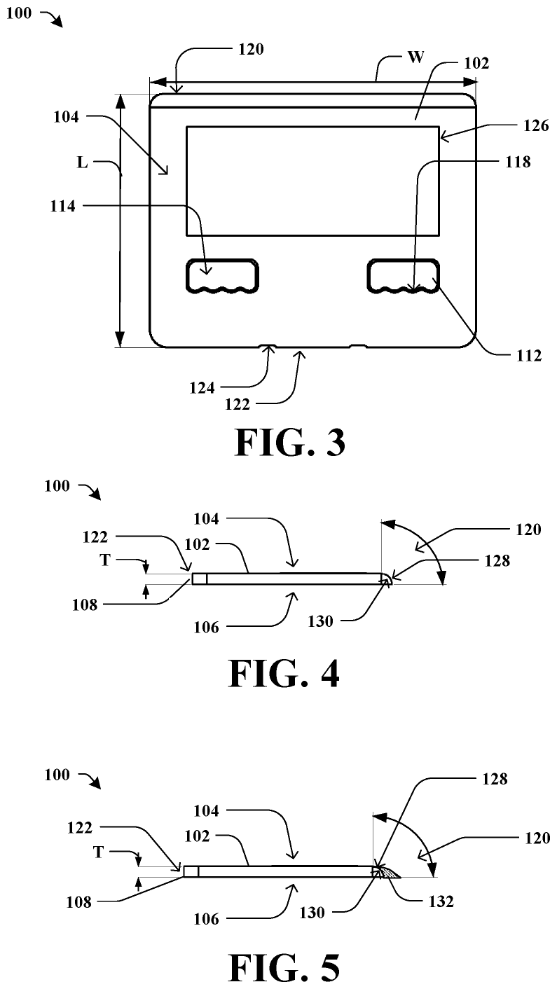

Turning additionally to FIG. 3, a top-view of the exemplary multi-purpose tool is illustrated. Provided on the front surface 104 is a smooth area 126 that is arranged between the handle portions 112 and the scraping side 120. The smooth area 126 may advantageously be used for advertising a brand or company name. For example, a decal may be placed on the smooth area 126 of the front surface 104 of the body portion 102, or a name or image may be part of the mold to be displayed in area 126.

In some embodiments, the multi-purpose tool is rectangular and thus, has a width W and a length L. The width W may be in a range of between, for example, approximately eight inches and approximately sixteen inches, and the length L may be in a range of between, for example, approximately fifteen inches and approximately twenty-one inches. The width W and the length L of the multi-purpose tool may be dependent upon the make and model of a user's vehicle, such as being dimensioned such that it fits in the door of a user's vehicle when it's not in use. The multi-purpose tool may also be dimensioned such that it can cover a floor mat and/or a trunk mat in a user's vehicle. Further, because of the few (if any) connection points of the monolithic structure of the tool, the tool can be cleaned and dried off easily, thereby preventing mold and mildew buildup on the tool and within a user's car for storage. Therefore, the multi-purpose tool may also be used to protect an interior of a vehicle. For example, a user may place a dirty object such as, for example, shoes, trash, plants, or the like in the main cavity 110 of the multi-purpose tool and place the front surface 104 of the multi-purpose tool on an interior surface of the vehicle to protect the interior of the vehicle from the dirty object. The outer edge portion 108 and the inner edge portion 116 that define the main cavity 110 assist in preventing a liquid (e.g., water, mud, etc.) or other unwanted substance from spilling onto the interior of the vehicle.

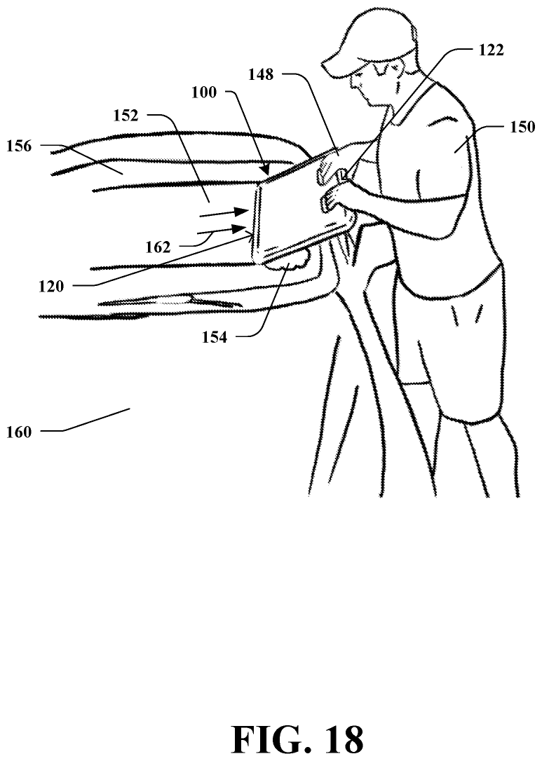

Turning now to FIG. 4, a side view of the multi-purpose tool of FIG. 3 is illustrated. The outer edge portion 108 extends from the body portion 102 at a rounded corner 128 at the scraping side 120 of the outer edge portion 108, The rounded corner 128 defines an inner concave area 130 of the main cavity 110 configured to collect a substance from an exterior of a vehicle when a user is using the multi-purpose tool in a pulling motion as will be described further in FIG. 18. Other regions of the outer edge portion 108, such as the scraping side 122, may meet with the body portion 102 at a ninety degree angle or may also meet with the body portion 102 at a rounded corner. A thickness T of the multi-purpose tool is equal to a height of the outer edge portion 108 and is in a range of between, for example, approximately five tenths of an inch and approximately two inches.

Turning now to FIG. 5, the multi-purpose tool 100 may further include a squeegee structure 132 arranged on and attached to the scraping side 120 proximate to the front surface 104 of the multi-purpose tool. The squeegee structure 132 may include a rubber-like material and may be configured to remove water or mud from an interior and/or exterior surface of a vehicle, such as a window. In some other embodiments, the squeegee structure 132 may be arranged on a different side of the outer edge portion 108, such as on a side of the outer edge portion 108 that is between and connects the scraping side 120 and the gripping side 122 of the multi-purpose tool. It will be appreciated that a microfiber cloth, a brush, or some other cleaning structure may be arranged on the outer edge portion 108 in addition to or in place of the squeegee structure 132 illustrated in FIG. 5.

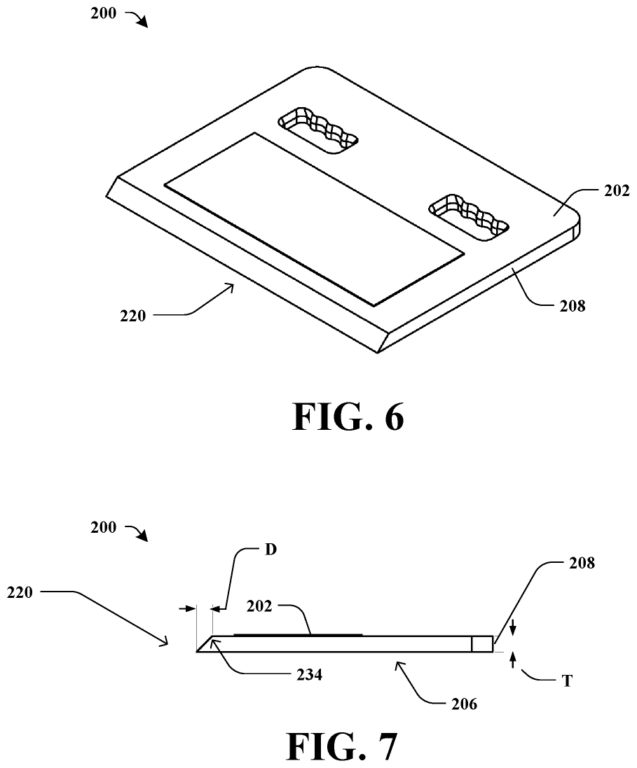

Turning now to FIGS. 6 and 7, an alternative embodiment of the multi-purpose tool is illustrated at reference numeral 200. The multi-purpose tool 200 is substantially the same as the above-referenced multi-purpose tool 100, and consequently the same reference numerals but indexed by 100 are used to denote structures corresponding to similar structures in the multi-purpose tools. In addition, the foregoing description of the multi-purpose tool 100 is equally applicable to the multi-purpose tool 200 except as noted below.

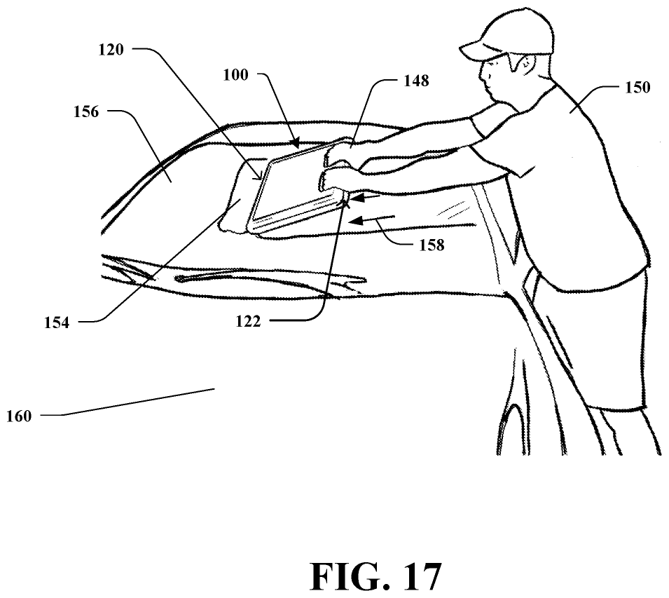

The outer edge portion 208 may extend from the back surface 206 of the multi-purpose tool at the scraping side 220 at an obtuse angle 234 such that the profile of the scraping side 220 in FIG. 7 exhibits a wedge. The scraping side 220 of the outer edge portion 208 may extend past the body portion 202 of the multi-purpose tool by a distance D in a range of between, for example, approximately five tenths of an inch and approximately two inches. In some other embodiments, additional regions of the outer edge portion 208 may also meet with the back surface 206 of the body portion 202 at an obtuse angle to form the wedge-like profile. The wedged scraping side 220 is configured to chisel ice or other unwanted substance away from an exterior of a vehicle when a user is using the multi-purpose tool in a pushing motion as will be described further in FIG. 17.

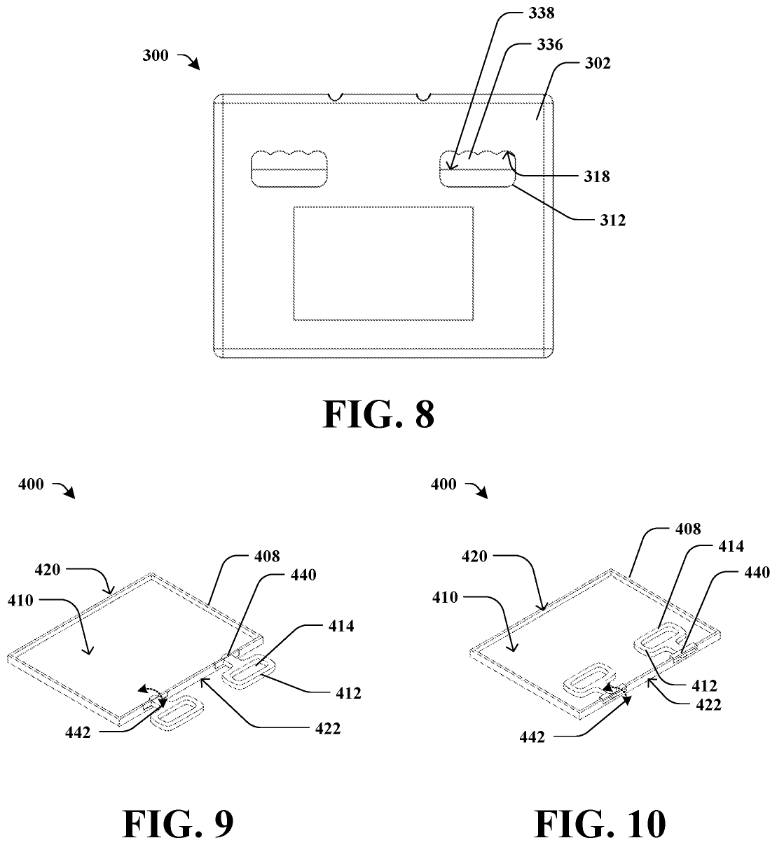

Turning now to FIG. 8, another alternative embodiment of the multi-purpose tool is illustrated at reference numeral 300. The multi-purpose tool 300 is substantially the same as the above-referenced multi-purpose tool 100, and consequently the same reference numerals but indexed by 100 are used to denote structures corresponding to similar structures in the multi-purpose tools. In addition, the foregoing description of the multi-purpose tool 100 is equally applicable to the multi-purpose tool 300 except as noted below.

The multi-purpose tool 300 may include a barrier structure 336 coupled to the body portion 302 at the handle portion 312. The barrier structure 336 may include a first piece and a second piece that meet at a seam 338 to close the openings (e.g., 114 of FIG. 1) of the handle portion 312 when the barrier structure 336 is in a first configuration. The first and second pieces of the barrier structure 336 are configured to flex and separate at the seam 338 to provide a passageway for a user's hand to grip the handle portion 312 when the barrier structure 336 is in a second configuration. The barrier structure 336 may be made of a suitable flexible material such as rubber or the like. When in the first configuration, the seam 338 seals the openings (e.g., 114 of FIG. 1) of the handle portion 312 such that the main cavity (e.g., 110 of FIG. 1) is capable of containing liquid if the multi-purpose tool is used to protect an interior of a vehicle.

Turning now to FIGS. 9 and 10, yet another alternative embodiment of the multi-purpose tool is illustrated at reference numeral 400. The multi-purpose tool 400 is substantially the same as the above-referenced multi-purpose tool 100, and consequently the same reference numerals but indexed by 100 are used to denote structures corresponding to similar structures in the multi-purpose tools. In addition, the foregoing description of the multi-purpose tool 100 is equally applicable to the multi-purpose tool 400 except as noted below.

The handle portion 412 may be a separate piece from the body portion 402 and operably coupled to the gripping side 422 of the outer edge portion 408 at a connection region 440. The handle portion 412 may include openings 414 configured to accommodate a user's hand. The handle portion 412 is configured to rotate about the connection region 440 as illustrated by arrow 442. The handle portion 412 is configured to rotate between an open position as illustrated in FIG. 9 and a closed position as illustrated in FIG. 10. In the open position, the handle portion 412 may be gripped and used for removing a substance from an exterior of a vehicle at the scraping side 420. In the closed position, the handle portion 412 may overlie the body portion 402 of the multi-purpose tool. The handle portion 412 may rest in the main cavity 410 of the multi-purpose tool for storage when in the closed position as illustrated in FIG. 10.

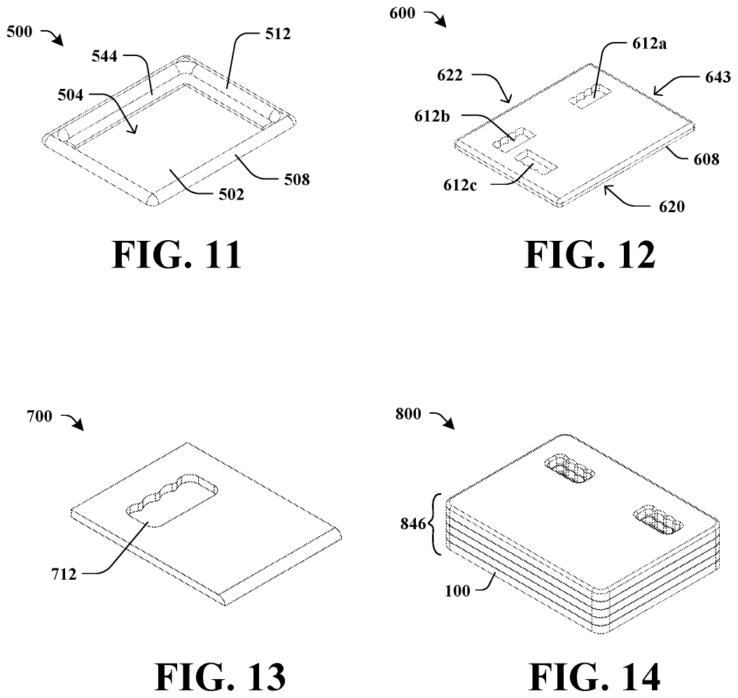

Turning now to FIG. 11, yet another alternative embodiment of the multi-purpose tool is illustrated at reference numeral 500. The multi-purpose tool 500 is substantially the same as the above-referenced multi-purpose tool 100, and consequently the same reference numerals but indexed by 100 are used to denote structures corresponding to similar structures in the multi-purpose tools. In addition, the foregoing description of the multi-purpose tool 100 is equally applicable to the multi-purpose tool 500 except as noted below.

The multi-purpose tool 500 may include a handle portion 512 that is defined by an elongated opening 544 arranged between the body portion 502 and the outer edge portion 508. In some embodiments, the elongated opening 544 may extend along two adjacent sides of the body portion 502. From the perspective view in FIG. 11, a front surface 504 of the multi-purpose tool 500 is visible.

Turning now to FIG. 12, yet another alternative embodiment of the multi-purpose tool is illustrated at reference numeral 600. The multi-purpose tool 600 is substantially the same as the above-referenced multi-purpose tool 100, and consequently the same reference numerals but indexed by 100 are used to denote structures corresponding to similar structures in the multi-purpose tools. In addition, the foregoing description of the multi-purpose tool 100 is equally applicable to the multi-purpose tool 600 except as noted below.

The multi-purpose tool 600 may include a first handle portion 612a laterally spaced apart from a second handle portion 612b and proximate to the gripping side 622 of the outer edge portion 108, and a third handle portion 612c arranged between the second handle portion 612b and the scraping side 620 of the outer edge portion 608. The third handle portion 612c may be arranged across from an additional scraping side 643 of the outer edge portion 608, which is adjacent to the scraping side 620, abuts the scraping side 120, and has a smaller length than the scraping side 620. The additional scraping side 643 may be applied to a surface on a vehicle when a user grips the third handle portion 612c, whereas the scraping side 620 may be applied to a surface on a vehicle when a user grips the first and second handle portions 612a, 612b. The third handle portion 612c and additional scraping side 643 provides more versatility for scraping. For example, the additional scraping side 643 may be better suited to remove a substance from a smaller area of a vehicle, such as a side window, than the longer scraping side 620 which may be better suited to remove a substance from a larger area of a vehicle such as a windshield. The scraping side 620 and the additional scraping side 643 may both be defined by rounded corners (e.g., 128 of FIG. 4) as shown, although it will be appreciated that the additional scraping side 643 may have a different structure than the scraping side 620. For example, the scraping side 620 may include a squeegee structure (e.g., 132 of FIG. 5), whereas the additional scraping side 643 may be include a wedge-like profile (e.g., 120 of FIG. 7).

Turning now to FIG. 13, yet another alternative embodiment of the multi-purpose tool is illustrated at reference numeral 700. The multi-purpose tool 700 is substantially the same as the above-referenced multi-purpose tool 200, and consequently the same reference numerals but indexed by 100 are used to denote structures corresponding to similar structures in the multi-purpose tools. In addition, the foregoing description of the multi-purpose tool 200 is equally applicable to the multi-purpose tool 700 except as noted below.

The multi-purpose tool 700 of FIG. 13 is substantially the same as the multi-purpose tool 200 in FIG. 6 but may include only one handle portion 712. In some such embodiments, the multi-purpose tool 700 may be smaller than other embodiments described herein for ease of storage in compact vehicles.

Turning now to FIG. 14, a stack 846 of multi-purpose tools 100 is provided at reference numeral 800. In some embodiments, the multi-purpose tools 100 can nest within one another to form a stack 846. This nesting feature allows for easy and cost-efficient shipping of the multi-purpose tools 100. Additionally, in a retail store, the stack 846 of multi-purpose tools 100 can be displayed without taking up a substantial amount of shelf space.

Turning now to FIGS. 15, 16, 17, and 18, a method of gripping the multi-purpose tool and of using the multi-purpose tool for removing a substance off of a vehicle will be provided. It will be appreciated that the other multi-purpose tools 200, 300, 400, 500, 600, and 700 may be utilized in a similar manner.

Turning to FIG. 15 and FIG. 16, the handle portions 112 of the multi-purpose tool are configured to accommodate a user's hands 148. The user may grip onto the multi-purpose tool by placing a palm of the hand 148 on the front surface 104 of the body portion, and wrapping fingers through the opening 114 of the handle portion 112. The handle portion 112 includes finger notches 118 configured to receive the user's fingers for the comfort of the user and also to provide a secure grip and the gripping side 122 includes thumb notches 124 configured to receive the user's thumbs for the comfort of the user and also for a secure grip. As best shown in FIG. 16, when gripped, the user's fingers and thumbs rest on the back surface 106 of the body portion 102 of the multi-purpose tool.

Turning to FIG. 17, a user 150 may apply the scraping side 120 of the multi-purpose tool to an exterior surface 156 of a vehicle 160 and push a substance 154 in a direction of arrows 158 off of the exterior surface 156 of the vehicle 160. The pushing step shown in FIG. 17 may be beneficial to chisel any solidified areas of the substance away from the exterior surface 156 of the vehicle 160.

Turning additionally to FIG. 18, the user may apply the scraping side 120 of the multi-purpose tool to the exterior surface 156 of the vehicle 160 and pull the substance 154 in a direction of arrows 162 off of the exterior surface 156 of the vehicle 160. The pulling direction indicated by the arrows 162 is opposite to the pushing direction indicated by arrows 158 in FIG. 17. The substance 154 collects within the main cavity (110 of FIG. 1) for efficient of the substance 154. The pulling step shown in FIG. 18 may be beneficial to remove any loose areas of the substance off of the exterior surface 156 of the vehicle 160.

The user 150 can alternate between the pushing step of FIG. 17 and the pulling step of FIG. 18 to quickly remove large amounts of the substance 154 (e.g., snow, mud, leaves, ice, water, etc.) from the vehicle 160. Because of the larger size of the tool, the user 150 can quickly remove the substance 154 to prevent obstructed views during driving. Upon completion of removing the substance 154 from the exterior surface 156 of the vehicle 160, the user 150 can store the multi-purpose tool on the floor of the interior of the vehicle 160, on a seat of the interior of the vehicle 160, in a door of the interior of the vehicle 160, or in the trunk of the interior of the vehicle 160. The user 150 can store dirty items within the main cavity 110 of the multi-purpose tool to prevent the interior of the vehicle 160 from getting dirty. The user 150 can also use the multi-purpose tool as a carrying mechanism. For example, the multi-purpose tool may be used to transport groceries from one's vehicle 160 into the house. Therefore, the multi-purpose tool has multiple purposes such that a user 150 can utilize multi-purpose tool during all months of the year in their vehicle 160.

The aforementioned systems, components, (e.g., cavities, handles, among others), and the like have been described with respect to interaction between several components and/or elements. It should be appreciated that such devices and elements can include those elements or sub-elements specified therein, some of the specified elements or sub-elements, and/or additional elements. Further yet, one or more elements and/or sub-elements may be combined into a single component to provide aggregate functionality. The elements may also interact with one or more other elements not specifically described herein.

While the embodiments discussed herein have been related to the apparatus, systems and methods discussed above, these embodiments are intended to be exemplary and are not intended to limit the applicability of these embodiments to only those discussions set forth herein.

The above examples are merely illustrative of several possible embodiments of various aspects of the present application, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (e.g., that is functionally equivalent), even though not structurally equivalent to the disclosed structure which performs the function in the illustrated implementations of the invention. In addition although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising.”

This written description uses examples to disclose the embodiments of the application, including the best mode, and also to enable one of ordinary skill in the art to practice the embodiments, including making and using any devices or systems and performing any incorporated methods. The patentable scope of the invention is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

What is claimed is:

1. A multi-purpose tool for vehicles, the multi-purpose tool comprising:
a body portion having a front surface and a back surface;
an outer edge portion extending around a periphery of the body portion and extending away from the back surface of the body portion in an extension direction, the back surface of the body portion and the outer edge portion defining a cavity; and
a first handle portion defined by an opening in the body portion.

2. The multi-purpose tool of claim 1, wherein the opening extends through the body portion, and wherein the multi-purpose tool further comprises an inner edge portion surrounding and defining the opening, wherein the inner edge portion extends away from the back surface of the body portion in the extension direction.

3. The multi-purpose tool of claim 2, wherein the cavity is defined by a space confined by the inner edge portion, the outer edge portion, and the body portion.

4. The multi-purpose tool of claim 1, wherein the first handle portion comprises finger notches configured to accommodate fingers of a user's hand for gripping.

5. The multi-purpose tool of claim 4, wherein the outer edge portion comprises a thumb notch that extends inward towards the first handle portion and that is configured to accommodate a thumb of the user's hand when gripping the first handle portion.

6. The multi-purpose tool of claim 1, wherein the outer edge portion comprises a scraping region extending along an outer edge of the body portion that is opposite to the first handle portion, wherein the scraping region of the outer edge portion comprises a rounded corner such that the scraping region is concave with respect to the cavity.

7. The multi-purpose tool of claim 1, wherein the outer edge portion comprises a scraping region extending along an outer edge of the body portion that is opposite to the first handle portion, and wherein the scraping region has a wedge-like profile configured to chisel ice away from a surface and/or configured to squeegee a material from a surface.

8. The multi-purpose tool of claim 1, further comprising a second handle portion laterally spaced from the first handle portion, and wherein the first and second handle portions are arranged opposite to a first outer edge of the body portion.

9. The multi-purpose tool of claim 8, further comprising a third handle portion arranged opposite to a second outer edge of the body portion, wherein the second outer edge is shorter than the first outer edge, and wherein the second outer edge abuts the first outer edge.

10. The multi-purpose tool of claim 1, further comprising a barrier structure coupled to the body portion at the first handle portion, wherein the barrier structure comprises a first piece and a second piece, wherein the first piece and second piece are configured to close the opening of the first handle portion when the barrier structure is in a first configuration, and wherein the first piece and the second piece are configured to provide passageway through the opening of the first handle portion when the barrier structure is in a second configuration.

11. A multi-purpose tool for vehicles, the multi-purpose tool comprising:
a body portion having a front surface and a back surface;
an outer edge portion extending around a periphery of the body portion and extending away from the back surface of the body portion, wherein the back surface of the body portion and the outer edge portion define a cavity; and
a first handle portion defined by an opening extending through the body portion, the first handle portion being configured to accommodate fingers of a user's hand for gripping,
wherein a gripping side of the outer edge portion is configured to accommodate a thumb of the user's hand when gripping the first handle portion, and
wherein the outer edge portion comprises a scraping side arranged opposite to the gripping side.

12. The multi-purpose tool of claim 11, further comprising finger notches extending inward toward the opening and configured to receive fingers of a user's hand for gripping.

13. The multi-purpose tool of claim 11, wherein the scraping side meets the back surface of the body portion at an obtuse angle.

14. The multi-purpose tool of claim 11, further comprising a barrier structure coupled to the body portion at the first handle portion, wherein the barrier structure comprises a first piece and a second piece, wherein the first piece and second piece are configured to close the opening of the first handle portion when the barrier structure is in a first configuration, and wherein the first piece and the second piece are configured to provide passageway through the opening of the first handle portion when the barrier structure is in a second configuration.

15. The multi-purpose tool of claim 11, wherein the gripping side of the outer edge portion comprises a thumb notch that extends inward towards the first handle portion and that is configured to accommodate the thumb of the user's hand.

16. A method of removing a substance from a vehicle:
gripping a gripping side of a multi-purpose tool at a first handle portion, the multi-purpose tool comprising a body portion having a front surface and a back surface, an outer edge portion extending around a periphery of the body portion and extending away from the back surface of the body portion, wherein the back surface of the body portion and the outer edge portion define a cavity, and the first handle portion defined by an opening integrated with the body portion;
applying a scraping region of edge portion of the multi-purpose tool to an exterior area of the vehicle that comprises the substance, the scraping region of the edge portion being opposite to the gripping side of the multi-purpose tool;
removing the substance from the exterior area of the vehicle with the scraping region of the edge portion of the multi-purpose tool, wherein the removal step is conducted by:
pushing the substance off of the exterior area of the vehicle with the scraping region of the edge portion of the multi-purpose tool, wherein the pushing is conducted in a first direction; and
pulling the substance off of the exterior area of the vehicle with the scraping region of the edge portion of the multi-purpose tool, wherein the pulling is conducted in a second direction opposite to the first direction.

17. The method of claim 16, wherein the substance collects within the cavity during the pulling step.

18. The method of claim 16, wherein the first handle portion is operably coupled to the body portion and configured to rotate about the body portion between an open position and a closed position.

19. The method of claim 18, wherein the method further comprises moving the first handle portion into the open position prior to the gripping step.

20. The method of claim 16, wherein the scraping region comprises a wedge-like profile such that the pushing step further comprises chiseling the substance off of the exterior area of the vehicle.
